(19) United States
(12) Patent Application Publication
(10) Pub. No.: US 2024/0386537 A1
(43) Pub. Date: Nov. 21, 2024

(54) IMAGE PERSPECTIVE RECTIFICATION SYSTEM

(71) Applicant: Capital One Services, LLC, McLean, VA (US)

(72) Inventor: Jie ZOU, McLean, VA (US)

(73) Assignee: Capital One Services, LLC, McLean, VA (US)

(21) Appl. No.: 18/197,427

(22) Filed: May 15, 2023

(51) Int. Cl. G06T 5/00; G06K 7/14; G06T 3/00

(52) U.S. Cl. CPC G06T 5/80; G06K 7/1413; G06K 7/1417; G06T 3/10; G06T 2207/20081; G06T 2207/20084; G06T 2207/30176

(57) ABSTRACT

Disclosed herein are system, method, and computer program product embodiments for an image rectification system. An embodiment operates by receiving an image of a physical object comprising graphical data having an undefined perspective distortion. It is determined that an image transformation is to be performed on the received image. The image is provided to a neural network configured to generate a plurality of transformation parameters corresponding to the perspective distortion. The neural network is trained on a set of training data including a first set of images including objects having similar graphical data, to the received image, in a readable orientation, and a second set of images with a known perspective transformation. The image transformation is performed on the received image, based on the values for the plurality of transformation parameters, to generate a rectified image with the graphical data oriented within a readable threshold.

### BACKGROUND

It has become commonplace for organizations, apps, and websites to request that a user take a picture of a document and send it to them. These pictures may be of identification cards, credit cards, insurance information, financial statements, or other documents. The receiving organization may then use these documents to verify the user's identity or other information, or perform some other processing for or on behalf of the user. However, one of the challenges is that these images will often be taken by a user using a mobile phone or tablet at varying angles (e.g., geometric distortions) with differing lighting conditions, degradations, blurriness, and other distortions that may make it difficult, if not impossible, to read or extract data from the image.

Existing methods usually detect key points (e.g. 4 corner points) using conventional image processing algorithms (e.g. Harris corner detector) or deep learning based models (e.g. various deep learning based key point detectors). The transformation parameters are then estimated based on these key points. Because the existing methods rely on a limited number of key points, they are not robust, and do not work when the key points are occluded (e.g., ID document corner points are covered by fingers).

### BRIEF DESCRIPTION OF THE DRAWINGS

The accompanying drawings are incorporated herein and form a part of the specification.

FIG. 1 is a block diagram illustrating an example image rectification system (IRS), according to some embodiments.

FIG. 2 is a flowchart illustrating example operations of an image rectification system (IRS), according to some embodiments.

FIG. 3 is an example computer system useful for implementing various embodiments.

In the drawings, like reference numbers generally indicate identical or similar elements. Additionally, generally, the leftmost digit(s) of a reference number identifies the drawing in which the reference number first appears.

### DETAILED DESCRIPTION

Provided herein are system, apparatus, device, method and/or computer program product embodiments, and/or combinations and sub-combinations thereof, for providing an image perspective rectification system.

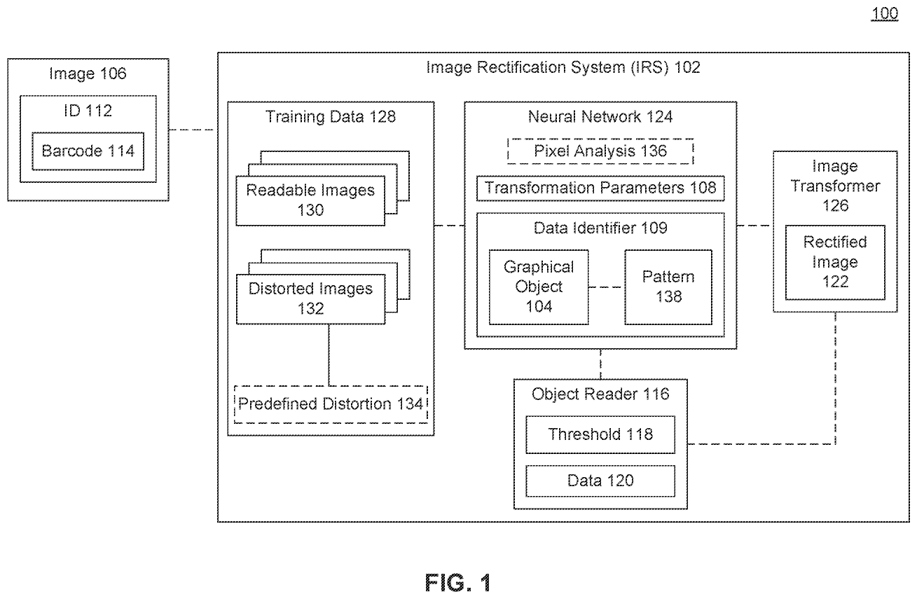

FIG. 1 is a block diagram 100 illustrating an example image rectification system (IRS) 102, according to some embodiments. IRS 102 may perform image rectification or transformations to correct or reduce the perspective distortion to a graphical object 104 that was received as part of an image 106. IRS 102 may produce a rectified version of the original image 106 that has been distortion corrected, or adjusted, such that a graphical object 104 from the rectified image 122 may be read by an object reader 116 to obtain, read, or extract the required data 120.

Graphical object 104 may be any object, image, pattern, or shape within an image 106 that has a defined structure, such as a structure for which IRS 102 includes a pre-defined structure that may be stored by or accessible to IRS 102. Examples of graphical objects 104 include, but are not limited to, numbers, pictures, letters, symbols, shapes, barcodes, QR (quick response) codes, etc. In some embodiments, an image 106 may include multiple graphical objects 104 which are detected and processed by IRS 102 as described herein.

In some embodiments, a user may take an image 106 with their imaging device (e.g., a mobile phone camera. tablet computer camera, scanner, etc.) and submit the image 106 via a processor and transmitter coupled to the imaging device to an app or website integrated with or connected to IRS 102. IRS 102 may receive image 106 from the app or directly from the user, and object reader 116 may attempt to read the graphical object 104 in the image 106. If, however, object reader 116 cannot read the graphical object 104, IRS 102 may process and rectify or transform the image 106 to make the graphical object 104 more readable.

In some embodiments, this image processing by IRS 102 may be performed on an initially unreadable image and may include generating or computing a set of transformation parameters 108, indicating a distortion of one or more of the graphical objects 104. As will be discussed in greater detail below, these transformation parameters 108 may then be used to perform an image transformation, reorientation, or rectification on the image 106 and/or one or more of the graphical objects 104 within the image 106, to make the image 106, or at least the graphical object(s) 104 of the image 106, readable to an object reader 116.

Image 106 may be a photograph or image file of a physical object taken by an imaging device. The imaging device may be part of a mobile device, such as a mobile phone, tablet computer, personal digital assistant, or laptop computer, or other photographic or computing device, such as a scanner or webcam. A physical object may be any three-dimensional or real-world, physical object that includes physical edges (e.g., that do not curve or bend, or that are not curved or bent), but may be flexible or made of flexible material. Examples of physical objects include, but are not limited to, street signs, bulletin boards, identification cards, credit cards, license plates, laminated paper, billboards, or any other objects or documents that include strong textual, numerical, or symbolic patterns of where numbers, letters, symbols, images, or other objects or shapes often appear on the physical object.

In the example illustrated, an identification card (ID) 112 is only one example of a physical object. ID 112 may include various data or information for image transformation prior to reading (e.g., by an object reader 116), including but not limited to a barcode 114. In some embodiments, ID 112 may also include alphanumeric text and symbols that may be read in addition to or in lieu of barcode 114 as graphical objects 104. Graphical object 104 may include any data which may be read from image 106, and may include one or multiple different objects or symbols.

In some embodiments, the actual graphical objects 104 may not be known to or stored by IRS 102 when the image 106 is received. For example, IRS 102 may process multiple images 106 of different license plates taken by a camera, for which the states and/or letters/numbers and images of the license plate are not known to or provided to (e.g., predefined) IRS 102 prior to processing. In some embodiments, IRS 102 may determine and output the actual lettering of each license plate as part of its image processing. For example, in some embodiments, IRS 102 may use optical character recognition (OCR) processing to identify the words or letters in an image 106.

As noted above, barcode 114 is one example of a graphical object 104. Barcode 114 may be a visual representation of data in a machine-readable form (e.g., readable by object reader 116 which may be a barcode reader). In some embodiments, barcode 114 may include a set of horizontal or vertical lines at varying widths, and may include a QR code.

As noted above, an organization may ask a user to submit a copy of their identification 112 for verification or authorization purposes in performing some transaction. The user may take a picture of their identification 112, and submit image 106 of their ID 112 including the barcode 114 to IRS 102 for processing.

The image(s) 106 received from different users can vary in their image quality or readability, even if the different users take images of similarly formed identification cards 112 (e.g., such as drivers' licenses from the same state). Different users may use different cameras, mobile phones, or other computing devices to take images 106. Further, the users may have different lighting in the pictures, and may take the pictures from different angles, including upside down. In some embodiments, the same user may submit multiple images 106, all of which have different levels of distortion. For example, a user may take a front picture and a back picture of their identification 112.

All these image variations may make it difficult, if not impossible, for an object reader 116 to read the barcode 114 or other graphical objects 104 from the submitted image 106. In some embodiments, object reader 116 may either be a handheld scanner used by a user or electronic scanner that is configured to automatically read barcodes 114 or other graphical objects 104 from images 106. In some embodiments, object reader 116 may be a person or human being who is tasked with reading data from the image 106.

In some embodiments, object reader 116 may have a maximum readability threshold 118 in terms of what is an acceptable level of distortion of a graphical object 104 that can still be read by object reader 116. For example, threshold 118 may be 20 degrees. As such, any image 106 with a distortion of greater than 20 degrees of a graphical object 104, may deemed unreadable or unacceptable for object reader 116. A skilled artisan will recognize that other measures of distortion may instead or additionally be considered in determining readability or acceptability of graphical object 104.

However, for incoming images 106, the level of distortion of the graphical object(s) 104 may be undefined. For example, IRS 102 may not have been provided any range or indication of a measure as to how much (if any) distortion is included in the incoming images 106. In some embodiments, images 106 received by IRS 102 may be tested by being directly submitted to object reader 116, prior to rectification, to determine whether or not image rectification processing is necessary on the image 106. If object reader 116 is able to read graphical object(s) 104, such as barcode 114, then no further image processing may be required. However, if barcode 114 is unreadable, then it may be determined that the level of distortion of image 106 exceeds threshold 118 and further processing may be required as described herein. In some embodiments, all images 106 may be received and processed for distortion as described herein, prior to being submitted to object reader 116.

In some embodiments, IRS 102 may submit image 106 to a neural network 124 for processing. Neutral network 124 may include a collection of computing devices that are interconnected and are capable of neural network type processing, artificial intelligence processing, and/or machine learning in processing data. Neural network 124 may be, for example, a convolutional neural network (“CNN”). As a CNN, neural network 124 may include a backbone for visual feature extraction and several heads for transformation parameter estimation. An existing backbone (e.g. MobileNet (A. G. Howard, M. Zhu, B. Chen et al., “Mobilenets: efficient convolutional neural networks for mobile vision applications,” 2017, https://arxiv.org/abs/1704.04861, incorporated herein by reference in its entirety), ResNet (He, Kaiming; Zhang, Xiangyu; Ren, Shaoqing; Sun, Jian (2016). Deep Residual Learning for Image Recognition. 2016 IEEE Conference on Computer Vision and Pattern Recognition (CVPR). Las Vegas, NV, USA: IEEE. pp. 770-778. arXiv: 1512.03385. incorporated herein by reference in its entirety), etc.) can be used, and the number of heads depends on the number of parameters that one wants to estimate. Neural network 124 may be trained to identify a physical object, such as a license plate or ID 112, within image 106 and/or one or more graphical objects 104 (such as barcode 114 or alphanumeric text) within the physical object.

In some embodiments, neural network 124 may compute a set of transformation parameters 108 indicating a level or degree of distortion (such as perspective distortion) of one or more of the graphical objects 104 within an input image 106. For example, a perfectly aligned image 106 may include a perpendicular or top-down bird's eye type view of barcode 114 and may include zero distortion. Transformation parameters 108 may indicate a deviation, such as an image angle, from this perpendicular or other view which may be determined as being optimal for reading by object reader 116. In some embodiments, the optimal view may include its own angle of distortion, beyond zero, which may then be used as the baseline for computing transformation parameters 108.

In some embodiments, threshold 118 may indicate what values constitute an acceptable set of transformation parameter values (e.g., that are readable by object reader 116). In some embodiments, neural network 124 may generate a set of transformation parameters 108 for image 106 and compare the transformation parameters 108 to threshold 118. If the transformation parameters 108 are within threshold 118, then image 106 may be submitted directly to object reader 116 without further processing. However, if the transformation parameters 108 exceed threshold 118, then IRS 102 may continue with image rectification as described herein.

In some embodiments, a data identifier 109 may identify one or more graphical objects 104 in image 106, such as barcode 114 or one or more letters, numbers, or other symbols. In some embodiments, this identified graphical object 104 may have a predefined set of patterns 138. For example, barcode 114 may be defined as an image having a set of vertical and parallel lines of varying thickness (e.g., pattern 138). Alternatively, the capital letter ‘A’, may have a predefined and recognizable or detectable pattern 138.

In some embodiments, neural network 124 may perform a pixel analysis 136 in computing one or more of transformation parameters 108 for at least one identified graphical object 104 with a detectable or predefined pattern 138. In performing pixel analysis 136 on barcode 114, neural network 124 may perform a pixel-by-pixel analysis to determine or detect whether or not the pixels correspond to pattern 138. By performing pixel analysis 136 and analyzing the document image at the pixel level, neural network 124 is more reliable than existing methods that merely detect and match limited features points, such as the four corner points of a document. Pixel analysis 136 is able to work even with severe occlusion, such as where the corner points are covered.

With barcode 114, pixel analysis 136 may include determining whether the pixels of barcode 114 are vertical and parallel (in correspondence with pattern 138). Any deviation from the predefined verticality of the barcode 114 may be identified as a deviation and used to compute transformation parameters 108.

In some embodiments, if image 106 includes multiple graphical objects 104, then one object or a subset of the graphical objects 104 may be selected for pixel analysis 136. In some embodiments, IRS 102 may presume that the remaining graphical objects 104 of the same image 106 include the same deviation or can be transformed using the same transformation parameters 108, thereby saving processing time and computing resources relative to processing and computing transformation parameters 108 on every identified graphical object 104 with a predefined or detectable pattern 138. In some embodiments, if there are multiple graphical objects 104, the left-most or top-most graphical object 104 may be selected for processing. Or, for example, the first or last identified graphical object 104 may be selected for processing.

In some embodiments, the values of transformation parameters 108, computed by neural network 124, may be used by an image transformer 126 to actually perform image rectification on the input image 106 and/or its identified graphical object(s) 104 to generate rectified image 122. Image transformer 126 may be configured to perform various or different types of image rectification or transformation processes. Two example transformation processes include perspective transformation and affine transformation. An affine transformation may be a linear mapping method that preserves points, straight lines, and planes, and may be used to correct for geometric distortions or deformations. Perspective transformation may be a mapping method that restores parallelism to horizontal or vertical lines by tilting one plane.

In some embodiments, the type of transformation or rectification performed by image transformer 126 may impact which parameters and how many transformation parameters 108 are to be generated by neural network 124. In some embodiments, image transformer 126 may be configured to perform affine transformations or perspective transformations and may be part of or communicatively coupled with neural network 124.

As just noted, different neural networks 124 may be trained with different training data 128 to generate different transformation parameters 108 for different types of transformations to be performed by one or more image transformers 126. Training data 128 may include a set or various sets of data that is used to train the neural network 124 to generate transformation parameters 108 on any variety of possible incoming images (e.g., image 106).

In some embodiments, the training data 128 may include a set of readable images 130 and distorted images 132. The readable images 130 may be images with either no distortion or a predefined distortion (e.g., stored by IRS 102) that is within the readability threshold 118. In some embodiments, readable images 130 may include one or more graphical objects 104 similar to the graphical objects 104 for which neural network 124 may be trained to identify (e.g., via data identifier 109) and transform. For example, readable images 130 may include various barcodes 114 in various readable orientations or distortions (e.g., within threshold 118). If, for example, object reader 116 is reading barcodes from various drivers' licenses, then readable images 130 may include images of licenses from a variety of different states or from all the states. In some embodiments, training data 128 may also include images that do not have a graphical object 104 to train neural network 124 to identify when the graphical object 104 is missing.

Training data 128 may also include a set of distorted images 132, each with its own predefined or previously measured and determined distortion 134 that exceeds threshold 118. In some embodiments, distorted images 132 may include the same readable images 130 or a subset of readable images 130 that have been intentionally distorted. For example, the same identification card may be used as both a readable image 130 and distorted image 132, the variance between the images being the level of distortion of the distorted image 132 exceeding threshold 118 by a predefined or previously determined value or predefined distortion 134.

Predefined distortion 134 may indicate the previously measured or detected degree of re-orientation or distortion, or the values of transformation parameters 108 that should be generated or output by neural network 124 based on processing the distorted images 132. In some embodiments, different distorted images 132 may include different predefined distortions 134. In some embodiments, different distorted images 132 with different predefined distortions 134 may correspond to multiple distorted versions of a same readable image 130.

In some embodiments, training samples showing distortion (such as distorted images 132) are generated automatically from samples having no distortion or whose distortion is within the readability threshold (such as readable images 130). In this manner, no manual annotation may be needed for the training samples. To automatically generate training samples, images of a given target document (e.g., an ID with a barcode) are created in the ideal orientation. These images may be automatically generated or captured with an image capture device, such as a camera or scanner. Distorted images are then generated by applying perspective transformation to the created target document image. The perspective transformation parameters may be randomly generated. This allows a large amount of transformation parameter pairs and transformed image pairs to be generated, thus resulting in a large training dataset. Because the perspective transformation is a physical transformation, the transformed images have certain distinct visual properties. For example, the straight lines in barcodes are still straight lines, but the original parallel lines may now intersect in a vantage point after distortion. Similarly, for documents, parallel text lines may exhibit the same visual properties. These visual properties can then be captured by a CNN (convolutional neural network). The CNN can then be trained to learn the mapping function from image pixels to transformation parameters by learning from the training dataset. In some embodiments, the CNN used for identifying distortion parameters can be the same CNN used to identify the physical object itself, thus saving on computation resources.

Once neural network 124 has been trained on a set of training data 128, the neural network 124 may continue to improve its processing based on feedback on whether or not images 106 were properly processed (e.g., based on the output of transformation parameters 108 and/or a rectified image 122) and machine learning or artificial intelligence processing.

The rectified image 122 may be a transformed version of image 106, or at least the identified graphical object(s) 104 that may have been extracted or copied from image 106 and that is to be read by object reader 116, that is within the readability threshold 118. The rectified image 122 may then be submitted or otherwise made available to object reader 116. Object reader 116 may read or extract data 120 from reading the graphical object 104 from the rectified image 122. This data 120 may include any data that is readable from image 106. This data 120 and/or the rectified image 122 may then be output or returned to the user, app, website, or other program or destination associated with the image 106.

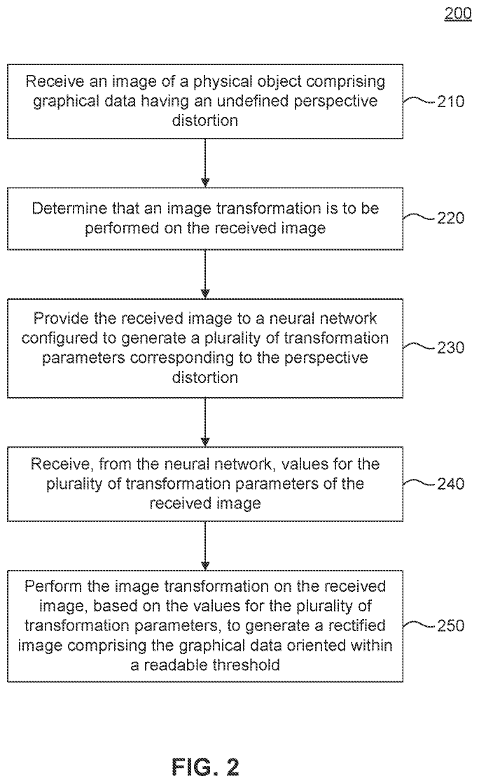

FIG. 2 is a flowchart of a method 200, illustrating example operations of an image rectification system (IRS) 102, according to some embodiments. Method 200 can be performed by processing logic that can comprise hardware (e.g., circuitry, dedicated logic, programmable logic, microcode, etc.), software (e.g., instructions executing on a processing device), or a combination thereof. For example, various steps in method 200 may be performed using one or application programming interfaces (APIs) operating on one or more processing devices. It is to be appreciated that not all steps may be needed to perform the disclosure provided herein. Further, some of the steps may be performed simultaneously, or in a different order than shown in FIG. 2, as will be understood by a person of ordinary skill in the art. Method 200 shall be described with reference to FIG. 1. However, method 200 is not limited to the example embodiments thereof.

In 210, an image of a physical object comprising graphical data having an undefined perspective distortion is received. For example, IRS 102 may receive image 106, which may be of an ID 112 that has a barcode 114, and which may include an undefined level of distortion. The identification card or ID 112 is an example of a physical object (e.g., an object without bends or folds that may complicate the computation of transformation parameters 108). The image 106 may be received from a user and include an undefined level of distortion, e.g., which may include any distortion measure that is not stored by or accessible to IRS 102 prior to the processing of image 106.

In 220, it is determined that an image transformation is to be performed on the received image. For example, IRS 102 may receive image 106 from object reader 116 indicating that the barcode 114 is unreadable by object reader 116 and thus includes a distortion that exceeds threshold 118. Or, for example, IRS 102 may receive image 106 and automatically perform transformation processing as described herein without a prior test by object reader 116. In some embodiments, IRS 102 may determine whether or not the image 106 is to be transformed after transformation parameters 108 have been generated and based on a comparison of the transformation parameters 108 to a readability threshold 118.

In 230, the received image is provided to a neural network configured to generate a plurality of transformation parameters corresponding to the perspective distortion. For example, IRS 102 may submit or provide or make available image 106 to neural network 124, which may be trained to identify graphical objects 104 and compute or generate a set of transformation parameters 108 on image 106 or one or more of the graphical objects 104. In some embodiments, the transformation parameters 108 which are generated may correspond to the preselected type of image transformation that may be performed by image transformer 126, such as a perspective or affine transformation.

In 240, values for the plurality of transformation parameters of the received image are received from the neural network. For example, neural network 124 may output a set of transformation parameters 108 to image transformer 126. In some embodiments, neural network 124 may also indicate which graphical object(s) 104 were identified in image 106 and a location and/or bounds of those graphical object(s) 104 in image 106. In some embodiments, if transformation parameters 108 are within threshold 118, then no image transformation may be performed, and the image 106 may be submitted directly to object reader 116.

In 250, the image transformation is performed on the received image, based on the values for the plurality of transformation parameters, to generate a rectified image comprising the graphical data oriented within a readable threshold. For example, image transformer 126 may perform image transformation or rectification on either the graphical object(s) 104 of image 106, or the entire image 106, based on transformation parameters 108 to generate rectified image 122, which includes an acceptable level of distortion (which may be zero) within threshold 118. In some embodiments, the rectified image 122 may be re-submitted to neural network 124 which may compute a new set of transformation parameters 108 to compare to threshold 118 to verify that rectified image 122 will be readable by object reader 116.

In some embodiments, the rectified image 122 may then be provided to object reader 116 for reading. In some embodiments, object reader 116 may be a different device or part of a different system to which rectified image 122 is provided or otherwise made accessible. Object reader 116 may then read and return data 120 read from rectified image 122. If object reader 116 cannot read rectified image 122, the rectified image 122 may be re-submitted to neural network 124 for an additional round of processing as described herein, or an error may be indicated that the image 106 is unreadable.

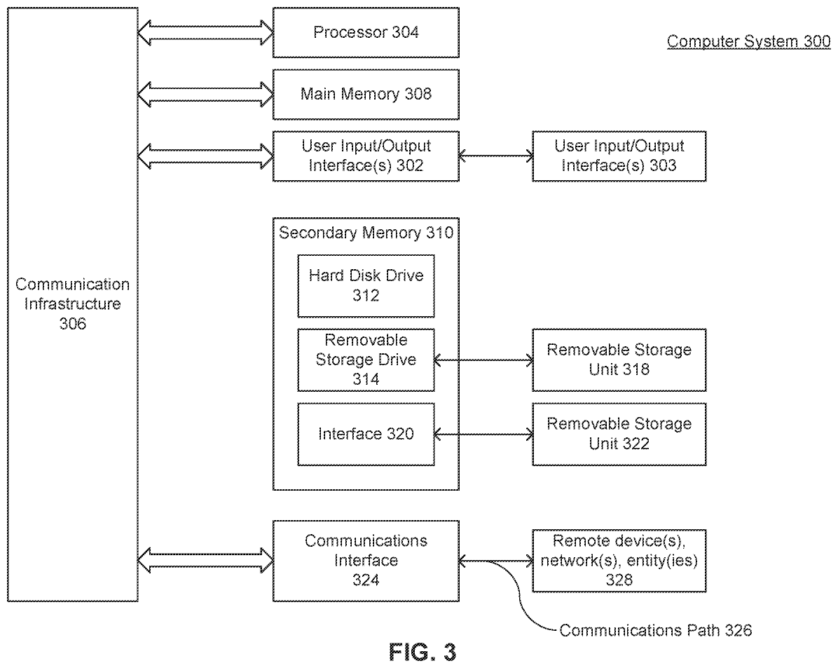

Various embodiments may be implemented, for example, using one or more well-known computer systems, such as computer system 300 shown in FIG. 3. One or more computer systems 300 may be used, for example, to implement any of the embodiments discussed herein, such as image rectification system 102 and/or method 200, as well as combinations and sub-combinations thereof.

Computer system 300 may include one or more processors (also called central processing units, or CPUs), such as a processor 304. Processor 304 may be connected to a communication infrastructure or bus 306.

Computer system 300 may also include customer input/output device(s) 303, such as monitors, keyboards, pointing devices, etc., which may communicate with communication infrastructure 306 through customer input/output interface(s) 302.

One or more of processors, including processor 304, may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 300 may also include a main or primary memory 308, such as random access memory (RAM). Main memory 308 may include one or more levels of cache. Main memory 308 may have stored therein control logic (i.e., computer software) and/or data.

Computer system 300 may also include one or more secondary storage devices or memory 310. Secondary memory 310 may include, for example, a hard disk drive 312 and/or a removable storage device or drive 314. Removable storage drive 314 may be a floppy disk drive, a magnetic tape drive, a compact disk drive, an optical storage device, tape backup device, and/or any other storage device/drive.

Removable storage drive 314 may interact with a removable storage unit 318. Removable storage unit 318 may include a computer usable or readable storage device having stored thereon computer software (control logic) and/or data. Removable storage unit 318 may be a floppy disk, magnetic tape, compact disk, DVD, optical storage disk, and/any other computer data storage device. Removable storage drive 314 may read from and/or write to removable storage unit 318.

Secondary memory 310 may include other means, devices, components, instrumentalities or other approaches for allowing computer programs and/or other instructions and/or data to be accessed by computer system 300. Such means, devices, components, instrumentalities or other approaches may include, for example, a removable storage unit 322 and an interface 320. Examples of the removable storage unit 322 and the interface 320 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 300 may further include a communication or network interface 324. Communication interface 324 may enable computer system 300 to communicate and interact with any combination of external devices, external networks, external entities, etc. (individually and collectively referenced by reference number 328). For example, communication interface 324 may allow computer system 300 to communicate with external or remote devices 328 over communications path 326, which may be wired and/or wireless (or a combination thereof), and which may include any combination of LANs, WANs, the Internet, etc. Control logic and/or data may be transmitted to and from computer system 300 via communication path 326.

Computer system 300 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 300 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 300 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 300, main memory 308, secondary memory 310, and removable storage units 318 and 322, as well as tangible articles of manufacture embodying any combination of the foregoing. Such control logic, when executed by one or more data processing devices (such as computer system 300), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 3. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A computer-implemented method, comprising:
receiving an image of a physical object comprising graphical data having an undefined perspective distortion;
determining that an image transformation is to be performed on the received image;
providing the received image to a neural network configured to generate a plurality of transformation parameters corresponding to the perspective distortion, wherein the neural network was trained on a set of training data comprising:
a first set of images including objects having similar graphical data, to the received image, in a readable orientation; and
a second set of images with a predefined perspective transformation and predefined parameters, corresponding to the plurality of transformation parameters, for each of the second set of images;
receiving, from the neural network, values for the plurality of transformation parameters of the received image; and
performing the image transformation on the received image, based on the values for the plurality of transformation parameters, to generate a rectified image comprising the graphical data oriented within a readable threshold.

2. The computer-implemented method of claim 1, further comprising:
providing the rectified image to a system configured to read the graphical data oriented within the readable threshold.

3. The computer-implemented method of claim 1, wherein the neural network is configured to perform pixel analysis on pixels of the graphical data of the image.

4. The computer-implemented method of claim 3, wherein the graphical data comprises one of a barcode or a QR (quick response) code.

5. The computer-implemented method of claim 4, wherein the barcode comprises parallel lines.

6. The computer-implemented method of claim 1, further comprising:
identifying a plurality of graphical objects on the received image;
selecting a first graphical object from the plurality of graphical objects; and
providing the first graphical object to the neural network in lieu of the received image, wherein the performing comprises performing the image transformation on the plurality of graphical objects based on the plurality of transformation parameters of the first graphical object.

7. The computer-implemented method of claim 1, wherein the determining comprises:
determining that the perspective distortion exceeds the readable threshold based on a system configured to read the graphical data being unable to read the graphical data of the image.

8. The computer-implemented method of claim 1, wherein the graphical data comprises alphanumeric text with a known pattern.

9. The computer-implemented method of claim 1, wherein the second set of images includes at least a subset of the first set of images re-oriented with the known perspective transformation.

10. A system comprising:
a memory; and
at least one processor coupled to the memory and configured to perform operations comprising:
receiving an image of a physical object comprising graphical data having an undefined perspective distortion;
determining that an image transformation is to be performed on the received image;
providing the received image to a neural network configured to generate a plurality of transformation parameters corresponding to the perspective distortion, wherein the neural network was trained on a set of training data comprising:
a first set of images including objects having similar graphical data to the received image, in a readable orientation; and
a second set of images with a known perspective transformation and known parameters, corresponding to the plurality of transformation parameters, for each of the second set of images;
receiving, from the neural network, values for the plurality of transformation parameters of the received image; and
performing the image transformation on the received image, based on the values for the plurality of transformation parameters, to generate a rectified image comprising the graphical data oriented within a readable threshold.

11. The system of claim 10, the operations further comprising:
providing the rectified image to a system configured to read the graphical data oriented within the readable threshold.

12. The system of claim 10, wherein the neural network is configured to perform pixel analysis on pixels of the graphical data of the image.

13. The system of claim 12, wherein the graphical data comprises one of a barcode or a QR (quick response) code.

14. The system of claim 13, wherein the barcode comprises parallel lines.

15. The system of claim 10, the operations further comprising:
identifying a plurality of graphical objects on the received image;
selecting a first graphical object from the plurality of graphical objects; and
providing the first graphical object to the neural network in lieu of the received image, wherein the performing comprises performing the image transformation on the plurality of graphical objects based on the plurality of transformation parameters of the first graphical object.

16. The system of claim 10, wherein the determining comprises:
determining that the perspective distortion exceeds the readable threshold based on a system configured to read the graphical data being unable to read the graphical data of the image.

17. The method of claim 1, wherein the graphical data comprises alphanumeric text with a known pattern.

18. The system of claim 10, wherein the second set of images includes at least a subset of the first set of images re-oriented with the known perspective transformation.

19. A non-transitory computer-readable medium having instructions stored thereon that, when executed by one or more processors, cause the one or more processors to perform operations comprising:
receiving an image of a physical object comprising graphical data having an undefined perspective distortion;
determining that an image transformation is to be performed on the received image;
providing the received image to a neural network configured to generate a plurality of transformation parameters corresponding to the perspective distortion, wherein the neural network was trained on a set of training data comprising:
a first set of images including objects having similar graphical data, to the received image, in a readable orientation; and
a second set of images with a known perspective transformation and known parameters, corresponding to the plurality of transformation parameters, for each of the second set of images;
receiving, from the neural network, values for the plurality of transformation parameters of the received image; and
performing the image transformation on the received image, based on the values for the plurality of transformation parameters, to generate a rectified image comprising the graphical data oriented within a readable threshold.

20. The non-transitory computer-readable medium of claim 19, the operations further comprising:
providing the rectified image to a system configured to read the graphical data oriented within the readable threshold.
